(19) United States
(12) Patent Application Publication
(10) Pub. No.: US 2016/0073806 A1
(43) Pub. Date: Mar. 17, 2016

(54) ICE SEQUESTERING CONTAINER ASSEMBLY

(71) Applicant: Danny A. Heaton, Watertown, SD (US)

(72) Inventor: Danny A. Heaton, Watertown, SD (US)

(21) Appl. No.: 14/484,558

(22) Filed: Sep. 12, 2014

(51) Int. Cl. A47G 19/22; A23L 2/72

(52) U.S. Cl. CPC A47G 19/2211; A23L 2/72; A47G 2400/06; A23V 2002/00

(57) ABSTRACT

An ice sequestering container assembly includes a vessel having a bottom wall and a perimeter wall that is attached to and extends upwardly from the bottom wall. The perimeter wall has an upper edge defining an access opening extending into the vessel. A screen is mounted in the vessel that traverses an interior of the vessel to define an upper portion and a lower portion within the interior. The upper portion is positioned above the screen and includes the access opening. The screen is positioned nearer to the access opening than the bottom wall. The screen has a plurality of apertures therein to allow fluid to pass through the screen. The plurality of apertures includes at least five apertures and the apertures each have an area less than 1.0 cm². The screen prevents ice from moving from the lower portion into the upper portion when the ice is positioned in the bottom section and the vessel is filled with a fluid.

### BACKGROUND OF THE DISCLOSURE

### Field of the Disclosure

The disclosure relates to ice restraining drinking container devices and more particularly pertains to a new ice restraining drinking container device for preventing ice from falling towards a person as the person is drinking fluid from the device such that the fluid is not splashed or otherwise spilled onto the person.

### SUMMARY OF THE DISCLOSURE

An embodiment of the disclosure meets the needs presented above by generally comprising a vessel having a bottom wall and a perimeter wall that is attached to and extends upwardly from the bottom wall. The perimeter wall has an upper edge defining an access opening extending into the vessel. A screen is mounted in the vessel that traverses an interior of the vessel to define an upper portion and a lower portion within the interior. The upper portion is positioned above the screen and includes the access opening. The screen is positioned nearer to the access opening than the bottom wall. The screen has a plurality of apertures therein to allow fluid to pass through the screen. The plurality of apertures includes at least five apertures and the apertures each have an area less than 1.0 cm². The screen is configure to prevent ice from moving from the lower portion into the upper portion when the ice is positioned in the bottom section and the vessel is filled with a fluid.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a ice sequestering container assembly according to an embodiment of the disclosure.

FIG. 2 is a front perspective view of an embodiment of the disclosure.

FIG. 3 is a top view of an embodiment of the disclosure.

FIG. 4 is a cross-sectional view of an embodiment of the disclosure taken along line 4-4 of FIG. 1.

FIG. 5 is a side in-use view of an embodiment of the disclosure.

FIG. 6 is a side perspective view of an embodiment of the disclosure.

### DESCRIPTION OF THE PREFERRED EMBODIMENT

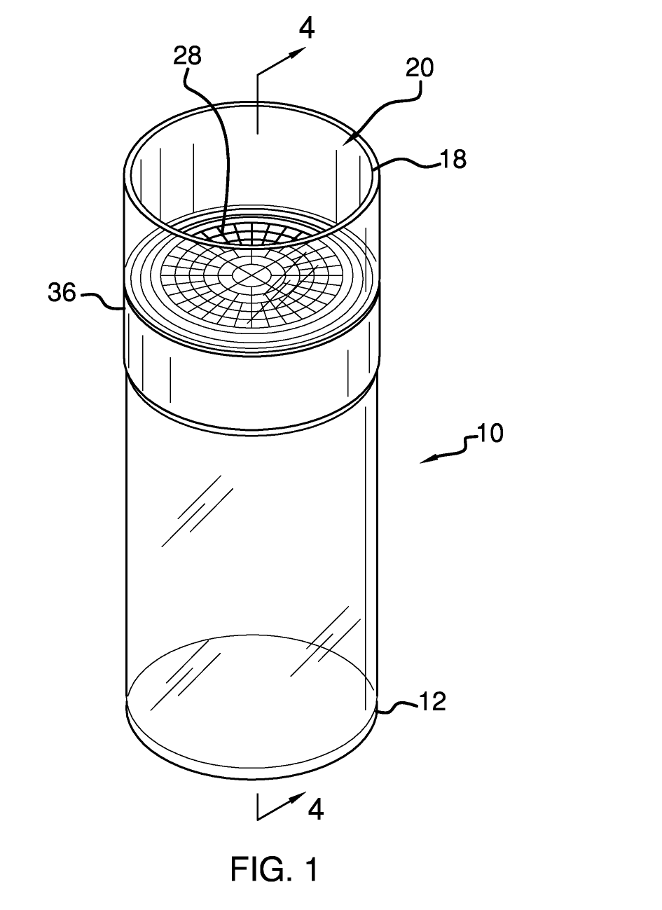

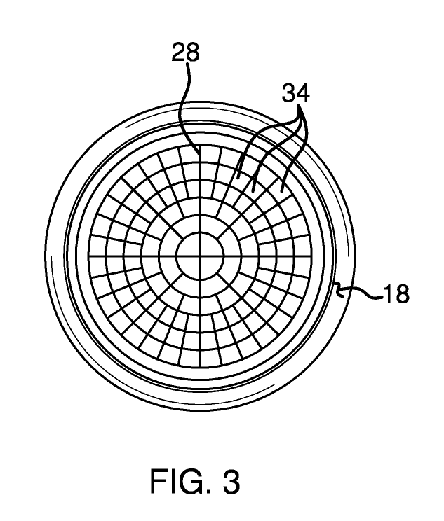

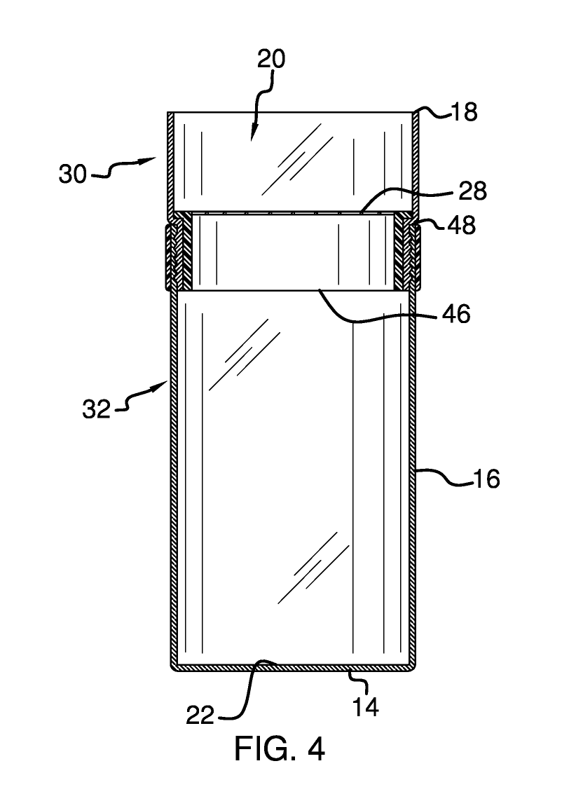

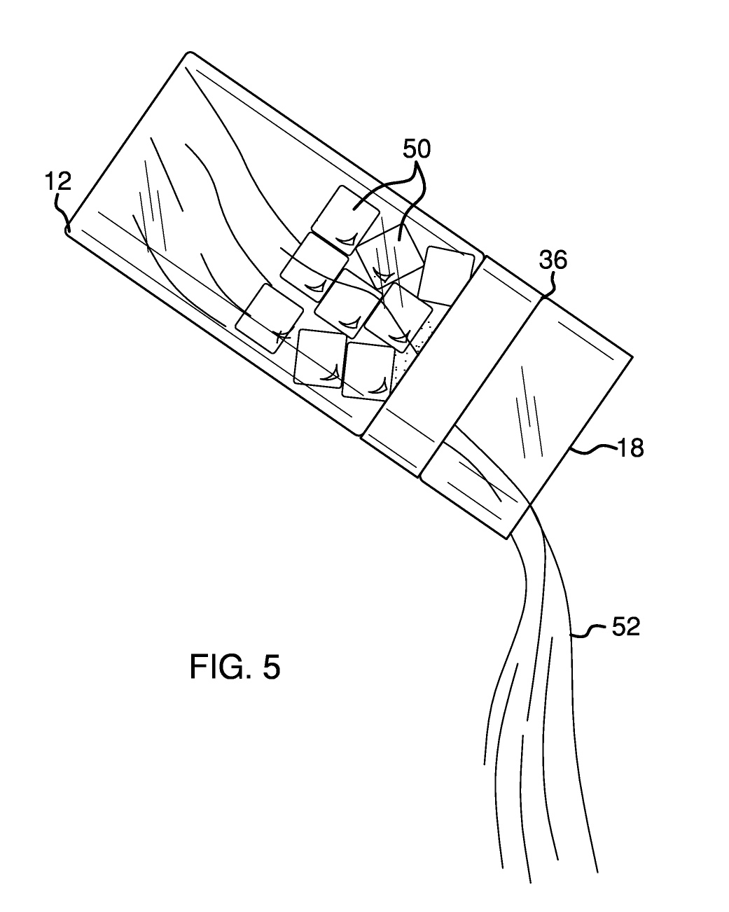

With reference now to the drawings, and in particular to FIGS. 1 through 6 thereof, a new ice restraining drinking container device embodying the principles and concepts of an embodiment of the disclosure and generally designated by the reference numeral 10 will be described.

As best illustrated in FIGS. 1 through 6, the ice sequestering container assembly 10 generally comprises a vessel 12 that has a bottom wall 14 and a perimeter wall 16 which is attached to and extends upwardly from the bottom wall 14. The perimeter wall 16 has an upper edge 18 defining an access opening 20 extending into the vessel 12 and the access opening 20 typically has a size approximately greater than at least 25.0 cm². The access opening 20 is generally used for drinking or pouring a fluid out of the vessel 12. Typically the access opening 20 may have a size which is equal to or greater than an upper surface 22 of the bottom wall 14. The vessel 12 may comprise any type of conventional drinking container or container used for holding and serving liquid beverages. As such, though the vessel 12 shown has a generally cylindrical shape, other shapes may be provided. Furthermore, as the vessel 12 may be used as pitcher 26, it may include one or more handles 24 to facilitate gripping of the vessel 12. The vessel 12 may be comprised of any conventional material used to hold fluids such as glass, metal, plastics or the like. Though not shown, a cover may be provided which is positionable over the access opening 20.

A screen 28 is mounted in the vessel 12 and the screen 28 traverses an interior of the vessel 12 to define an upper portion 30 and a lower portion 32 within the interior. The upper portion 30 is positioned above the screen 28 and includes the access opening 20. The screen 28 is generally positioned nearer to the access opening 20 than the bottom wall 22. However, the screen 28 is also spaced from the upper edge 18 a distance equal to at least 3.0 cm and may be more than 6.0 cm from the upper edge 18. The screen 28 has a plurality of apertures 34 therein to allow fluid to pass through the screen 28. The plurality of apertures 34 includes at least five apertures 34 and the apertures 34 each have an area, or opening size, less than 1.0 cm². Generally, the apertures 34 make up greater than 70%, and may be more than 80%, of the total surface area of the screen 28.

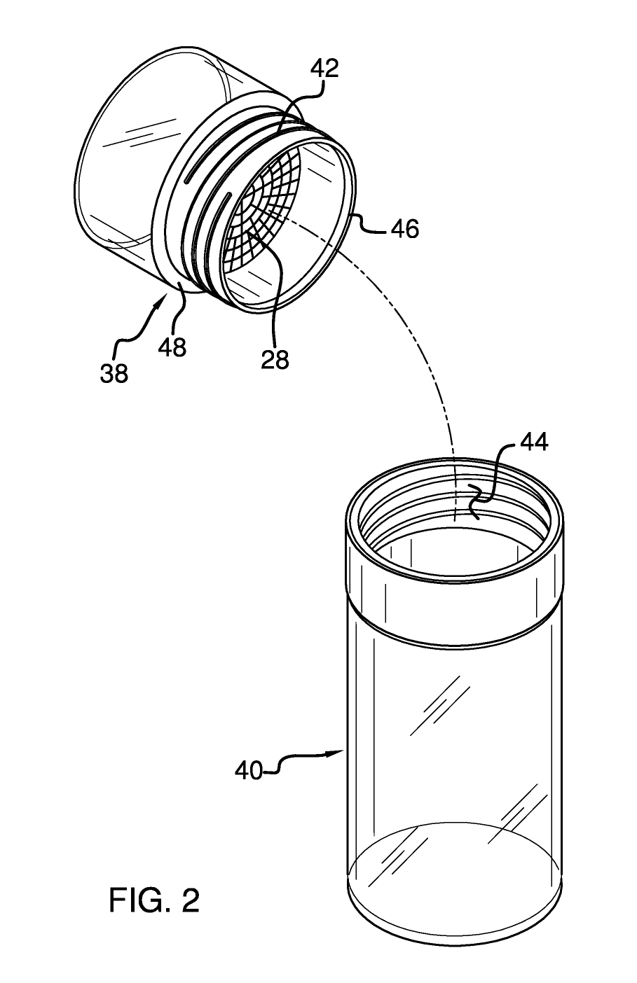

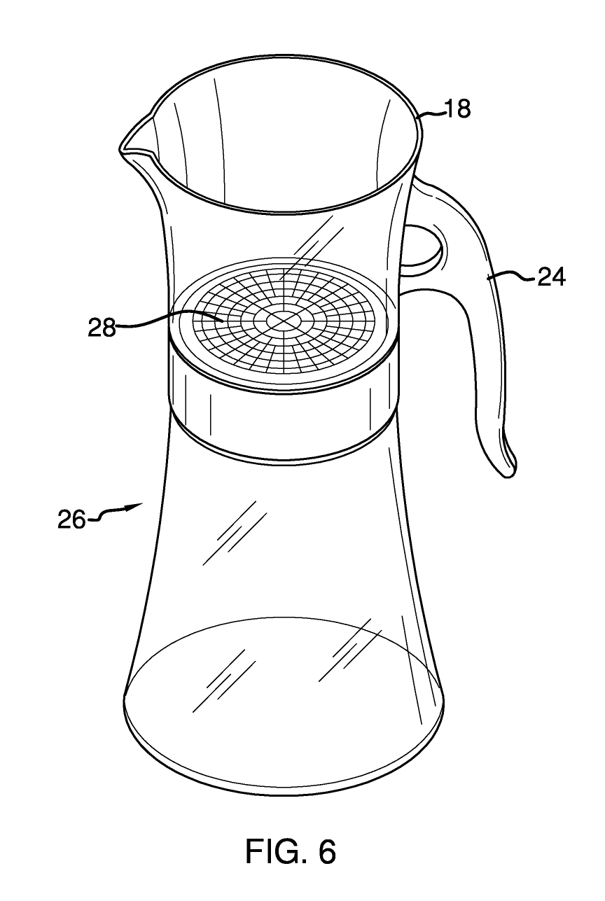

The vessel 12 has a break 36 therein to define an top section 38 and bottom section 40. The bottom section 40 includes the bottom wall 14. The upper 38 and lower 40 sections are removably attached together. A seal is formed when the upper 38 and lower 40 sections are attached together. As shown in FIG. 2, the top section 38 includes a first threaded mating member 42 and the bottom section 40 includes a second threaded mating member 44. The first 42 and second 44 threaded mating members are threadably engaged with each other. As can be seen in the Figures, the top section 38 includes exterior threading on a flange 46 which is inserted into and engaged with interior threading on the bottom section 40. However, it should be understood that the bottom section 40 could include the flange 46 and the exterior threading to engage interior threading on the top section 38. Gaskets, not shown, may also be utilized to further improve a seal between the upper 38 and lower 40 sections and other sealing means may be utilized though threading may be preferred. As shown in FIG. 6, if a handle 24 is shown it may be attached only to the top section 38.

As is further shown in the Figures, the screen 28 may be attached to the top section 38. The screen 28 may be provided such that it is removable from the top section 38. The screen 28 may typically be positioned nearer to a lower edge 48 of the top section 38 than the upper edge 18 of the perimeter wall 16. More particularly, the screen 28 may be positioned at a juncture of the flange 46 and the perimeter wall 16 of the top section 38 or it may be positioned near a free edge of the flange 46. Alternatively, the screen 28 may be either non-removably attached to the top section 38 or integral to the upper suction 38 such that the screen 28 and top section 38 are of singular construction. Further, it should be understood that if the screen 28 is removable, it may instead be removably positioned in the bottom section 40 or removably positioned between the upper 38 and lower 40 sections.

In use, the user will place ice in the bottom section 40 of the vessel 12 and then secure the upper 38 and lower 40 sections together. Ice 50 will be positioned beneath the screen 28 so that the ice 50 cannot move into the upper portion 30 of the vessel 12 when the vessel 12 is tipped during pouring or drinking. The user will then fill the vessel 12 with a fluid 52 and this will generally include the fluid attaining a level above the screen 28. The user may then drink fluid from the vessel 12 without concern that the ice 50 will move towards the upper edge 18 causing spillage of fluid onto the user. The size of the apertures 34 and their overall area of coverage ensure even flow outwardly of the vessel 12 without concern that the ice 50 itself can move through the apertures 34. However, the ice 50 will still be able to effectively cool the fluid as intended.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An ice cube isolating container assembly comprising:
a vessel having a bottom wall and a perimeter wall being attached to and extending upwardly from said bottom wall, said perimeter wall having an upper edge defining an access opening extending into said vessel;
a screen being mounted in said vessel, said screen traversing an interior of said vessel to define an upper portion and a lower portion within said interior, said upper portion being positioned above said screen and including said access opening, said screen being positioned nearer to said access opening than said bottom wall, said screen having a plurality of apertures therein to allow fluid to pass through said screen, said plurality of apertures including at least five apertures, said apertures each having an area less than 1.0 cm²; and
wherein said screen is configured to prevent ice from moving from said lower portion into said upper portion when the ice is positioned in said bottom section and said vessel is filled with a fluid.

2. The ice cube isolating container assembly according to claim 1, wherein said access opening has a size greater than 25.0 cm².

3. The ice cube isolating container assembly according to claim 1, wherein said vessel has a break therein to define an top section and bottom section, said upper and bottom sections being removably attached together.

4. The ice cube isolating container assembly according to claim 3, wherein said top section includes a first threaded mating member and said bottom section includes a second threaded mating member, said first and second threaded mating members being threadably engaged with each other.

5. The ice cube isolating container assembly according to claim 3, wherein said bottom section includes said bottom wall and said top section including said screen.

6. An ice cube isolating container assembly comprising:
a vessel having a bottom wall and a perimeter wall being attached to and extending upwardly from said bottom wall, said perimeter wall having an upper edge defining an access opening extending into said vessel, said access opening having a size greater than 25.0 cm²;
a screen being mounted in said vessel, said screen traversing an interior of said vessel to define an upper portion and a lower portion within said interior, said upper portion being positioned above said screen and including said access opening, said screen being positioned nearer to said access opening than said bottom wall, said screen having a plurality of apertures therein to allow fluid to pass through said screen, said plurality of apertures including at least five apertures, said apertures each having an area less than 1.0 cm²;
said vessel having a break therein to define an top section and bottom section, said bottom section including said bottom wall and said top section including said screen, said upper and bottom sections being removably attached together and a seal is formed when said upper and bottom sections are attached together, wherein said top section includes a first threaded mating member and said bottom section includes a second threaded mating member, said first and second threaded mating members being threadably engaged with each other; and
wherein said screen is configured to prevent ice from moving from said lower portion into said upper portion when the ice is positioned in said bottom section and said vessel is filled with a fluid.

7. A method of isolating an ice cube within a container, said method comprising the steps of:
providing a vessel having a bottom wall and a perimeter wall being attached to and extending upwardly from said bottom wall, said perimeter wall having an upper edge defining an access opening extending into said vessel, a screen being mounted in said vessel, said screen traversing an interior of said vessel to define an upper portion and a lower portion within said interior, said upper portion being positioned above said screen and including said access opening, said screen being positioned nearer to said access opening than said bottom wall, said screen having a plurality of apertures therein to allow fluid to pass through said screen, said plurality of apertures including at least five apertures, said apertures each having an area less than 1.0 cm²;
positioning ice cubes within said lower portion;
filling said container with a liquid such that said liquid moves over said screen, wherein said ice cubes are retained within said lower portion by said screen.

8. The method according to claim 7, wherein the step of providing said vessel further includes said access opening has a size greater than 25.0 cm².

9. The method of claim 7, further including:
said step of providing said vessel comprises said vessel having a break therein to define an top section and bottom section, said upper and bottom sections being removably attached together;
said step of positioning ice cubes within said lower portion includes first separating said top section from said bottom section, positioning said ice cubs in said bottom section and then attaching said top section to said bottom section.

10. The ice cube isolating container assembly according to claim 9, wherein said step of providing said vessel further comprises said top section includes a first threaded mating member and said bottom section includes a second threaded mating member, said first and second threaded mating members being threadably engaged with each other.
